(19) United States
(12) Patent Application Publication
(10) Pub. No.: US 2015/0310491 A1
(43) Pub. Date: Oct. 29, 2015

(54) DYNAMIC TEXT ADS BASED ON A PAGE KNOWLEDGE GRAPH

(71) Applicant: Yahoo! Inc., Sunnyvale, CA (US)

(72) Inventors: Reiner Kraft, Gilroy, CA (US); Viraj Chavan, Sunnyvale, CA (US)

(73) Assignee: Yahoo! Inc., Sunnyvale, CA (US)

(21) Appl. No.: 14/265,155

(22) Filed: Apr. 29, 2014

(51) Int. Cl. G06Q 30/02

(52) U.S. Cl. CPC G06Q 30/0263

(57) ABSTRACT

In one embodiment, location information indicating a region of a web page with which a user is interacting may be obtained. Contextual information pertaining to the region of the web page with which the user is interacting may be ascertained. Content may be obtained based, at least in part, upon the contextual information pertaining to the region of the web page with which the user is interacting. The content may then be provided for presentation to the user.

### BACKGROUND OF THE INVENTION

The disclosed embodiments relate generally to computer-implemented methods and apparatus for providing content to users.

When a user browses the Internet, the user may click on web pages that interest him or her. In addition, advertisements may be presented via web pages in many forms, including banner advertisements. Generally, the selection of these advertisements is performed prior to the presentation of the web pages to the user.

### SUMMARY OF THE INVENTION

The disclosed embodiments enable content to be selected dynamically and provided to a user as the user interacts with a web page. The content may include advertisements or other forms of content.

In one embodiment, location information indicating a region of a web page with which a user is interacting may obtained, where the region is one of a plurality of regions of the web page. Contextual information pertaining to the region of the web page with which the user is interacting may be ascertained. Content may be obtained based, at least in part, upon the contextual information pertaining to the region of the web page with which the user is interacting. The content may then be provided for presentation to the user.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a diagram illustrating an example system in which embodiments of the invention may be implemented.

FIG. 2 is a process flow diagram illustrating an example method of serving content in accordance with various embodiments.

FIG. 3 is a diagram illustrating an example segment of a User Centric Intent Taxonomy that may be implemented in accordance with various embodiments.

FIG. 4 is a diagram illustrating an example entity type that may be implemented in accordance with various embodiments.

FIG. 5 is a schematic diagram illustrating an example embodiment of a network in which various embodiments may be implemented.

FIG. 6 is a schematic diagram illustrating an example client device in which various embodiments may be implemented.

FIG. 7 is a schematic diagram illustrating an example computer system in which various embodiments may be implemented.

### DETAILED DESCRIPTION OF THE SPECIFIC EMBODIMENTS

Reference will now be made in detail to specific embodiments of the disclosure. Examples of these embodiments are illustrated in the accompanying drawings. While the disclosure will be described in conjunction with these specific embodiments, it will be understood that it is not intended to limit the disclosure to these embodiments. On the contrary, it is intended to cover alternatives, modifications, and equivalents as may be included within the spirit and scope of the disclosure as defined by the appended claims. In the following description, numerous specific details are set forth in order to provide a thorough understanding of the disclosure. The disclosed embodiments may be practiced without some or all of these specific details. In other instances, well known process operations have not been described in detail in order not to unnecessarily obscure the disclosure. The Detailed Description is not intended as an extensive or detailed discussion of known concepts, and as such, details that are known generally to those of ordinary skill in the relevant art may have been omitted or may be handled in summary fashion

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

In recent years, the Internet has been a main source of information for millions of users. These users rely on the Internet to search for information of interest to them. One conventional way for users to search for information is to initiate a search query through a search service's web page. Typically, a user can enter a query including one or more search term(s) into an input box on the search web page and then initiate a search based on such entered search term(s). In response to the query, the search service typically returns an ordered list of search result documents.

A document may be defined as a Uniform Resource Locator (URL) that identifies a location at which the document can be located. The document may be located on a particular web site, as well as a specific web page on the web site. For instance, a first URL may identify a location of a web page at which a document is located, while a second URL may identify a location of a web site at which the document can be located.

When a user submits a search query via a search engine, the search query may indicate precise information that the user seeks to obtain as a result of the search query. As a result, it is possible to identify and present content that is likely to be relevant to the user's search query. Often, the content will include a list of search results, as well as advertisements. Since the advertisements that are presented in relation to a user's search are relatively likely to be relevant to the user's specific search query, the click-through rate (CTR) and user engagement with the advertisements are likely to be high.

In contrast, when a user browses the Internet via a web browser and clicks on a web page, advertisements that are presented in conjunction with the web page are generally selected prior to receiving any textual input from the user. Such advertisements are typically selected based on a variety of factors, such as demographic information (e.g., age and/or gender), past Internet activities of the user and/or a geographical location of the user. Typically, a set of advertisements is obtained and provided for presentation to the user by an ad server, and the web page including the advertisements is rendered in the web browser.

When a user clicks on a web page, it is difficult to accurately ascertain the intent of the user or the information that the user seeks to obtain. It is possible to analyze the content of a given web page to assist in identifying content such as advertisements that may be of interest to the user. However, a web page often includes various different unrelated content items. As a result, it is difficult to accurately determine content such as advertisements that will be of interest to a user viewing a particular web page, leading to quality issues.

Once a web page is displayed and a user starts to interact with the web page, in many cases the user interacts with specific regions on the web page. For example, the user may use a mouse or other pointing device to interact with specific regions of a web page. As another example, the user may interact with specific regions of a web page using their finger on mobile devices such as mobile phones or tablets. The regions that capture the user's interest typically contain contextual information that may be used to refine the targeting of content such as advertisements.

The disclosed embodiments enable the targeting of content to be refined in real-time as the user interacts with a web page. By identifying a specific “active” region of a web page with which a user is interacting (or has most recently interacted), contextual information pertaining to the region of the web page with which the user is interacting may be ascertained. Content may then be identified based, at least in part, upon the contextual information and provided for presentation to the user. In this manner, content such as advertisements may be dynamically and continuously adjusted according to contextual information that is collected with each web page interaction.

While various examples disclosed herein refer to the presentation of advertisements, it is important to note that these examples are merely illustrative. Accordingly, the disclosed embodiments may enable content of various types to be identified and provided for presentation to a user.

Example System

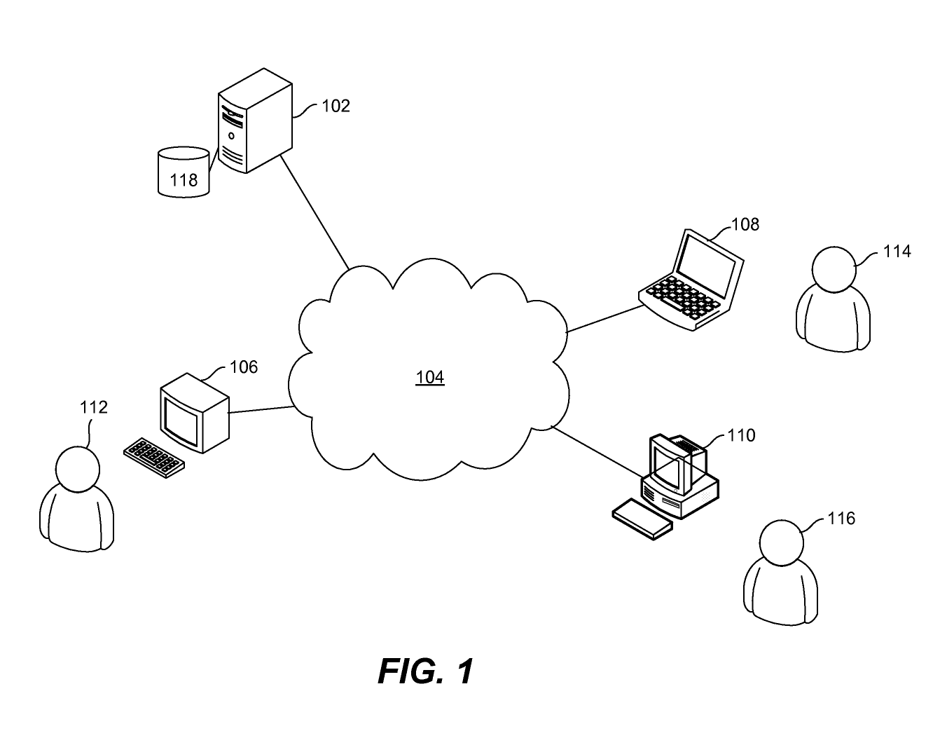

FIG. 1 is a diagram illustrating an example system in which various embodiments may be implemented. As shown in FIG. 1, the system may include one or more servers 102 associated with a web site such as a social networking web site. Examples of social networking web sites include Yahoo, Facebook, Tumblr, LinkedIn, Flickr, and Meme. The server(s) 102 may enable the web site to provide a variety of services to its users. More particularly, the server(s) 102 may include a web server, search server, and/or content server (e.g., ad server).

In accordance with various embodiments, the server(s) 102 may provide targeted content to users of the web site. A content server may store content for presentation to users. For example, a content server may be an “ad server” that stores online advertisements for presentation to users. “Ad serving” refers to methods used to place online advertisements on websites, in applications, or other places where users are more likely to see them, such as during an online session.

A plurality of clients 106, 108, 110 may access a web service on a web server via network 104. In addition, the clients 106, 108, 110 may access a search application (i.e., search service) on a search server via network the 104. The network 104 may take any suitable form, such as a wide area network or Internet and/or one or more local area networks (LAN's). The network 104 may include any suitable number and type of devices, e.g., routers and switches, for forwarding search or web object requests from each client to the search or web application and search or web results back to the requesting clients.

The disclosed embodiments may also be practiced in a wide variety of network environments (represented by network 104) including, for example, TCP/IP-based networks, telecommunications networks, wireless networks, etc. In addition, computer program instructions with which embodiments of the invention may be implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing a user profile for predicting user behavior, such as by group. For example, a user profile may include demographic characteristics such as age, income, sex, occupation, etc. Advertisements may be presented to users in a targeted audience based at least in part upon predicted user behavior(s).

Another approach includes tracking a user's path through a web site or network of sites, and updating a user profile based at least in part on pages or advertisements ultimately delivered. A correlation may be identified, such as for user purchases, for example. An identified correlation may be used to target potential purchasers by targeting content such as advertisements to particular users.

Many approaches to presenting targeted advertisements identify advertisements prior to the presentation of a web page. As a result, such approaches do not take advantage of the potentially valuable information that can be acquired by monitoring interactions of a user with a web page in real-time.

The disclosed embodiments enable content such as advertisements to be identified, selected, generated, transmitted, and/or otherwise provided for presentation to users as they interact with a web page. More particularly, the server(s) 102 may serve content to users via the web site (e.g., via display on a web page of the web site). In other embodiments, the content may be provided via electronic mail, Short Message Service (SMS), via a mobile device (e.g., text message), or via another medium such as digital television, which may be connected to the Internet. This may be desirable, for example, where a user is concurrently using multiple devices.

The server(s) 102 enable content such as advertisements to be identified and served based, at least in part, upon a specific region of a web page with which a user is currently interacting. An advertisement may include content pertaining to a product or service. The content typically includes text. However, it is important to note that an advertisement or offer may include text, one or more images, video, and/or audio. An advertisement may also include one or more hypertext links, enabling a user to proceed with the purchase of a particular product or service via the Internet.

The content (e.g., advertisement) that is identified or obtained may be presented within the web page or external to the web page. For example, the content may be presented via a toolbar or another segment of a display that does not block the web page. As another example, the content may be presented as a banner advertisement.

Embodiments disclosed herein may be implemented via the server(s) 102 and/or the clients 106, 108, 110. For example, various features may be implemented via a web browser and/or application on the clients 106, 108, 110. The disclosed embodiments may be implemented via software and/or hardware.

Content such as advertisements may be targeted to users further based upon a browsing context. The browsing context may include geographic information such as a location from which the user is browsing. In addition, the browsing context may include information from a user profile.

A variety of mechanisms may be implemented to support the generation of user profiles including, but not limited to, collecting or mining navigation history, stored documents, tags, or annotations, to provide a few examples. Profiles of users of a search engine, for example, may give a search engine provider a mechanism to retrieve annotations, tags, stored pages, navigation history, or the like, which may be useful for making relevance determinations of search results, such as with respect to a particular user.

In accordance with various embodiments, the server(s) 102 may have access to one or more user logs 118 (e.g., user databases) into which user information is retained for each of a plurality of users. This user information or a portion thereof may be referred to as a user profile. More particularly, the user profile may include public information that is available in a public profile and/or private information. The user logs 118 may be retained in one or more memories that are coupled to the server 102.

The user information retained in the user logs 118 may indicate a plurality of features for each user. More particularly, the features may include personal information such as demographic information (e.g., age and/or gender) and/or geographic information (e.g., residence address, work address, zip code, and/or area code). In addition, each time a user performs online activities such as clicking on a web page (or region thereof) or an advertisement, or purchasing goods or services, information regarding such activity or activities may be retained as user data in the user logs 118. For instance, the user data that is retained in the user logs 118 may indicate the identity of web sites visited, identity of ads that have been selected (e.g., clicked on) and/or a timestamp. In addition, the features may indicate a purchase history with respect to one or more products, one or more types of products, one or more services, and/or one or more types of services. Additional features may indicate one or more interests of the user.

The user logs 118 may further include query logs into which search information is retained. Each time a user performs a search on one or more search terms, information regarding such search may be retained in the query logs. For instance, the user's search request may contain any number of parameters, such as user or browser identity and the search terms, which may be retained in the query logs. Additional information related to the search, such as a timestamp, may also be retained in the query logs along with the search request parameters. When results are presented to the user based on the entered search terms, parameters from such search results may also be retained in the query logs. For example, an identity of the specific search results (e.g., URLs), such as the web sites, the order in which the search results are presented, whether each search result is a sponsored or algorithmic search result, the owner (e.g., web site) of each search result, and/or whether each search result is selected (i.e., clicked on) by the user (if any), may be retained in the query logs.

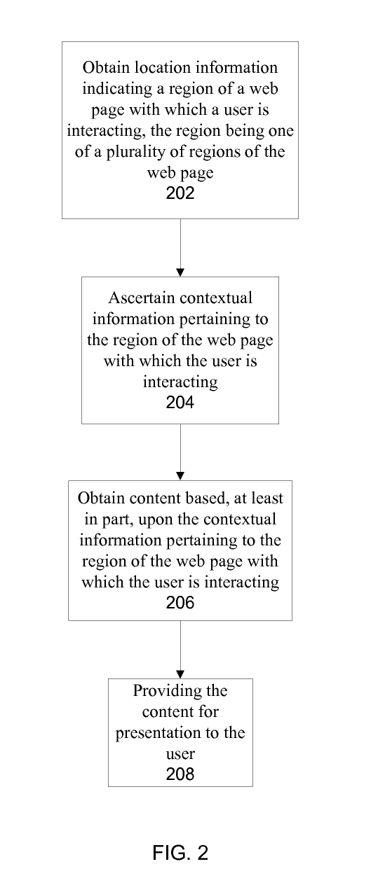

FIG. 2 is a process flow diagram illustrating an example method of serving content in accordance with various embodiments. Location information indicating a particular region of a web page with which a user is interacting may be obtained at 202, where the region is one of a plurality of regions of the web page. More particularly, interaction of the user with the region of the web page may be detected via a client device. The user interaction may be initiated or accomplished by the user via a mouse, pointer, keyboard, finger, voice command, or other suitable mechanism. Such an interaction may include, for example, selecting, scrolling, copying and/or pasting, cursor movement(s), and/or textual input. Upon detection of the user interaction with the region of the web page, the region may be identified as a particular one of a plurality of regions within the web page. For example, each of the different regions may be identified via horizontal and vertical coordinates, numerical identifiers, or another suitable mechanism. The client device may then transmit the location information to a server, enabling the server to identify suitable content.

Typically, the region of the web page with which the user is interacting will include text. However, the region may also include other types of content items such as images and/or hypertext links. As will be described in further detail below, the region may include one or more objects. For example, the objects may correspond to entities (e.g., material items), concepts, and/or categories.

Contextual information pertaining to the region of the web page with which the user is interacting may be ascertained at 204. For example, the server may retrieve or generate the contextual information. The contextual information may indicate one or more objects in the region of the web page, as well as context pertaining to those objects. More particularly, the contextual information may identify or indicate locations of the objects within the web page. In addition, the contextual information may indicate relationships between at least a portion of the objects. The contextual information may also be referred to as a semantic extraction.

As will be described in further detail below, the contextual information associated with a particular region of the web page may be ascertained based, at least in part, upon page information associated with the web page. The page information may include metadata that pertains to the plurality of regions of the web page. More particularly, the page information may identify objects within the web page. For example, an object may be identified as a “movie” or “movie times.” The page information may also include the specific objects within the web page. For example, an object may include specific text extracted from the web page or a particular movie referenced in the web page (e.g., “Gravity”). The page information may further specify or indicate specific locations or regions of the objects within the web page. In addition, the page information may further indicate relationships between at least a portion of the objects. For example, the objects may include one or more entities, concepts, and/or categories.

In accordance with various embodiments, page information associated with the web page may be obtained (e.g., retrieved or generated) when the web page is initially displayed. The contextual information pertaining to the pertinent region of the web page may then be ascertained using the page information in response to a user interaction with the region of the web page.

Content may be obtained at 206 based, at least in part, upon the contextual information pertaining to the region of the web page with which the user is interacting. More particularly, the contextual information pertaining to the pertinent region of the web page or an indication thereof may be provided to a content server such as an ad server for identification of suitable content. For example, the contextual information may identify the objects (e.g., “movies” or “recipes”) and/or include specific objects from the region of the web page (e.g., “Gravity” or “recipe for apple pie”). The content server may then return content such as an advertisement.

The content may also be obtained based, at least in part, upon a browsing context. For example, the browsing context may indicate a location of the client device at the time of the user interaction with the web page or region of the web page. As another example, the browsing context may include user information pertaining to the user of the client device, which may be obtained from a user profile of the user. An identity of the user of the client device may be ascertained via a variety of mechanisms. For example, the user may be identified via information in a user cookie, a user identifier (e.g., account identifier), a device identifier, a browser identifier, or other suitable mechanism.

The content may be provided at 208 for presentation to the user. More particularly, the server may provide the content to the client for presentation to a user. The content may be provided in conjunction with the web page. In some embodiments, the content may include one or more advertisements. The content may be provided without reloading the web page. In this manner, content such as advertisements presented within a web page may be continually updated as the user interacts with the web page.

The process may continue at 202 as the user continues to interact with the web page. Similarly, the process may repeat at 202 when the user interacts with a new web page.

The disclosed embodiments may be performed by a server and/or a remotely located device. For example, a server may obtain the location information from the device, ascertain the contextual information, obtain the content, and provide the content to the device for presentation to a user.

### EXAMPLE EMBODIMENTS

### Page Knowledge Graph

In accordance with various embodiments, the page information associated with a web page may be maintained in a page knowledge graph. In the following description, the terms page information and page knowledge graph will be used interchangeably.

In accordance with various embodiments, the web page with which the user is interacting may have an associated page knowledge graph. The page knowledge graph may be generated dynamically when the user initially clicks on the web page, or may be generated prior to the selection of the web page by the user. More particularly, each one of a plurality of web pages may have a corresponding one of a plurality of page knowledge graphs, where the page knowledge graphs are generated online or offline (e.g., via a batch process).

To generate a page knowledge graph for a given web page, a semantic analysis of the web page may be performed to obtain a semantic extraction. The page knowledge graph that is generated may indicate, for each one of a plurality of regions of a web page, a mapping between the region of the web page and the corresponding semantic extraction. More particularly, objects within the web page may be identified and/or obtained. The identification of the objects (e.g., “desserts” or “actors”) and/or the objects themselves (e.g., “apple pie” or “Tom Cruise”) may be stored in the page knowledge graph. The page knowledge graph may also specify or indicate specific locations or regions of the web page in which the respective objects are located. In addition, the page knowledge graph may further indicate relationships between at least a portion of the objects. The relationships may be ascertained, for example, from a global knowledge graph (KG) such as Freebase.

The objects may include, but are not limited to, entities, concepts, and/or categories. In addition, the objects may identify specific search-related tasks, which may be referred to as use cases. Moreover, the objects may also include extracted solutions for specific use cases. The identification of use cases within documents and extraction of solutions for use cases will be described in further detail below.

During the generation of a page knowledge graph, objects may be identified within a page using a set of rules or patterns. More particularly, pattern matching may be performed to identify objects within the web page. One example of the use of pattern matching to identify objects will be described in further detail below with respect to use cases.

A page knowledge graph may be represented in any suitable form that enables contextual information pertaining to a particular region of the web page to be easily obtained via a lookup process. For example, horizontal and vertical coordinates may be used as an index to the page knowledge graph. As another example, each one of a plurality of regions may have a corresponding region number that may be used as an index to the page knowledge graph.

Obtaining Content Using the Page Knowledge Graph

The page knowledge graph may be attached to the HTML Document Object Model (DOM) of a given web page. An identifier of the page knowledge graph, the page knowledge graph, or a portion of the page knowledge graph corresponding to the “active” region of the web page may be provided to a server such as a content server (e.g., ad server) for identification of suitable content. Where the entire page knowledge graph or an identifier thereof is provided to the server, an indication of the region of the web page with which the user is interacting (or has most recently interacted) may also be provided to the server. This indication may include, for example, an identification of the region of the web page with which a user is interacting or a change in location from a previous region with which the user was previously interacting. In this manner, metadata from a page knowledge graph may be made available for access by a content server.

Since messages are not guaranteed to be received by the content server in the order transmitted, a time stamp associated with a given user interaction with a particular region of the web page may also be determined and transmitted to the content server in association with the identifier of the page knowledge graph, the page knowledge graph, or portion thereof. The content server may use the time stamps from the messages that it has received to identify the region of the web page with which the user is currently interacting or has most recently interacted.

A content server such as an ad server may use the metadata pertaining to the specific region of the web page with which the user is currently interacting (or has most recently interacted) to identify suitable content for presentation to the user. The content may be presented in conjunction with the web page. While the content may be presented within the web page, the content may also be presented in an area external to (e.g., surrounding) the web page. Therefore, the targeted content need not block the web page that the user is accessing.

In some embodiments, additional information pertaining to the browsing context may be provided to the content server to further personalize the content. For example, geographic information such as a location of the client device from which the user is browsing may be provided to the content server. As another example, a user identifier of the user may be provided to the content server. To further illustrate the application of the disclosed embodiments, an example method of using a page knowledge graph to indicate locations of solutions to use cases within a given web page will be described in further detail below.

Generation of Page Knowledge Graph Pertaining to Use Cases and Extraction of Solutions to Use Cases Using the Page Knowledge Graph

The term “use case” may refer to a task that a user may be trying to accomplish by submitting a search query or interacting with a web page. For example, popular movie-related use cases include finding show times of a particular movie and searching for reviews of a particular movie.

In accordance with various embodiments, a user-centric intent taxonomy (UCIT) may represent a plurality of use cases, as well as relationships among the use cases. In the taxonomy, a use case may be associated with (e.g., mapped to) a set of query patterns that may each independently trigger the use case. Conversely, each query pattern may be associated with (e.g., mapped to) a set of use cases that may be triggered by the query pattern. Thus, a look up in the taxonomy may be performed for a query pattern to identify a corresponding set of use cases. Similarly, a look up in the taxonomy may be performed for a use case to identify a corresponding set of query patterns.

A query pattern may be represented in various forms. More particularly, a query pattern may be represented via rule(s) and/or pattern(s) that may be applied to a query to determine whether the query matches the rule(s) and/or pattern(s). Furthermore, a query pattern may be represented via any type of syntax. For example, a query pattern may be described using regular expressions or a syntax similar to regular expressions. In some implementations, a pattern language such as Jabba may be used to describe the query patterns.

Query patterns and mappings between query patterns and use cases can be compiled according to various algorithms. More particularly, the query patterns and/or mappings may be compiled manually by editors based on various session analysis approaches. Furthermore, the query patterns and/or mappings may also be compiled via a computer-learning algorithm. Therefore, each use case may be mapped to a corresponding set of query patterns.

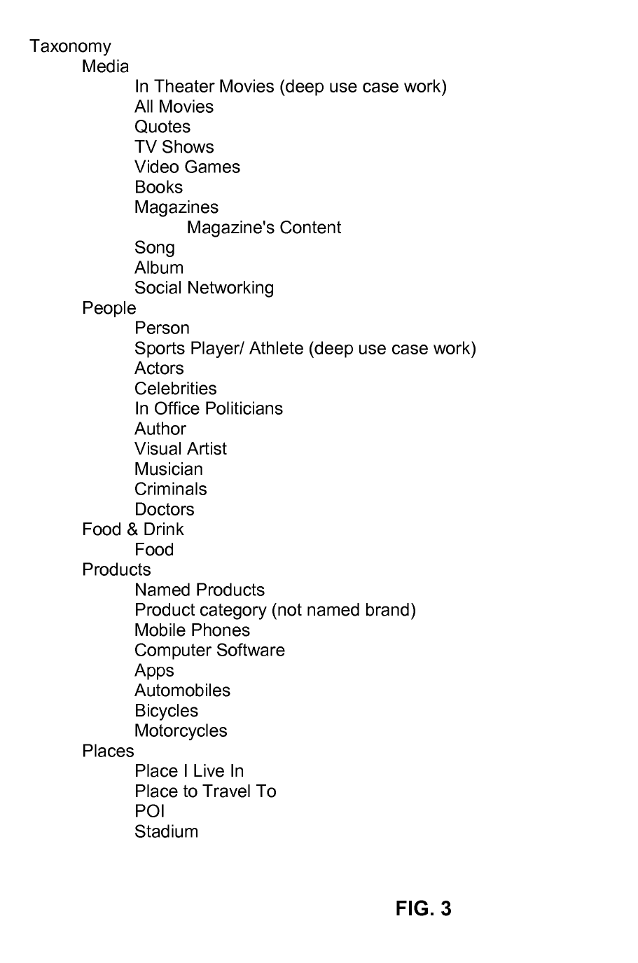

FIG. 3 is a diagram illustrating an example segment of a User Centric Intent Taxonomy that may be implemented in accordance with various embodiments. The taxonomy may include a plurality of categories (i.e., domains). In this example, the domains include media, people, food & drink, products, and places. Each domain may be associated with one or more entity types. In accordance with various embodiments, the term “entity type” may refer to a thing, concept, or event. In this example, the domain “media” is associated with entity types “In Theater Movies,” “All Movies,” “Quotes,” “TV Shows,” “Video Games,” “Books,” “Magazines,” “Song,” “Album,” and “Social Networking.”

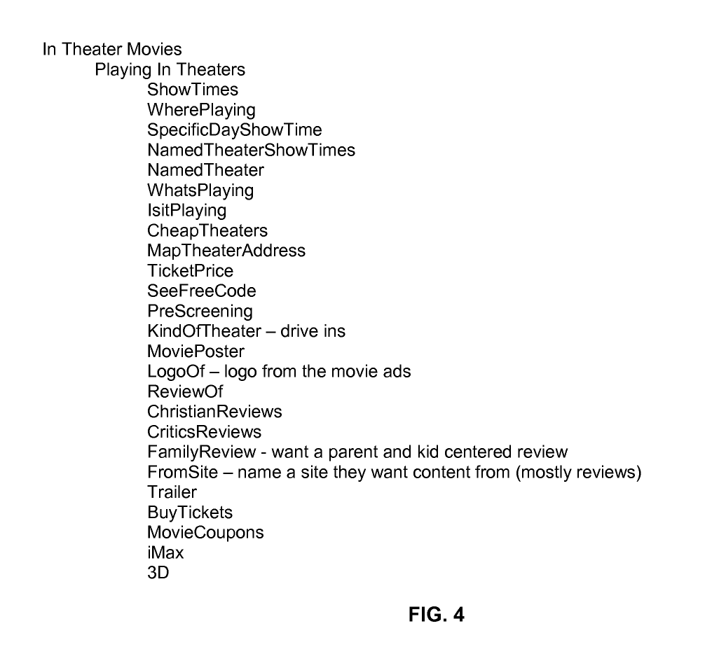

FIG. 4 is a diagram illustrating an example entity type in accordance with various embodiments. In this example, the entity type “In Theater Movies” is illustrated. Each entity type may be associated with one or more use cases. In this example, the entity type “In Theater Movies” is associated with a general use case “Playing In Theaters,” as well as specific use cases “ShowTimes,” “Whereplaying,” “SpecificDayShowtime,” “NamedTheaterShowTimes,” “NamedTheater,” “WhatsPlaying,” “IsitPlaying,” “CheapTheaters,” “MapTheaterAddress,” “TicketPrice,” “SeeFreeCode,” “PreScreening,” “KindofTheater” (e.g., drive ins), “MoviePoster,” “LogoOf” (logo from the movie ads), “ReviewOf,” “ChristianReviews,” “CriticsReviews,” “FamilyReview” (e.g., family-centric review), “FromSite,” “Trailer,” “BuyTickets,” “MovieCoupons,” “iMax,” and “3D.”

Each use case may be associated with an entity type. In this example, the use case “ShowTimes” is associated with the entity type “InTheaterMovies.” In addition, as discussed above, each use case may be associated with a set of query patterns that trigger the use case. Each query pattern may include one or more entity classes (e.g., [location], [movie], [product]). A query pattern may further include one or more additional terms such as context terms. Context terms may include terms that may further narrow and refine the use case in an intuitive way.

Each use case and entity type may have associated metadata. More particularly, the metadata may describe the corresponding use case or entity type in more detail or represent properties of the use case or entity type. For example, query patterns may be a property of a use case. Such metadata can be editorially obtained, curated and maintained, but can also be obtained using an algorithmic approach or a combination of editorial/algorithmic approach.

As described above, each use case in the taxonomy may be associated with an entity type. For example, the use case “ShowTimes” may be associated with the entity type “InTheaterMovies.” In addition, a query pattern may contain one or more entity classes (e.g., [location], [movie], [product]) and possible context terms. A popular use case for the “InTheaterMovies” entity type is the “Showtimes” use case, meaning that a user is interested in learning about current show times of a movie at a given or nearby movie theater. A set of query patterns associated with this use case may include one or more rules and/or patterns such as “[movie][location] [theater_name] showtimes.” An example query that would match this query pattern is “Gravity Santa Clara AMC showtimes.” This use case could also be associated with a similar query pattern “[movie] [location] where playing” and/or other variations of some or all of those entity types and possibly additional context terms.

In accordance with various embodiments, web pages may be processed offline or online to map use cases to Uniform Resource Locators (URLs) (and their corresponding regions within the URLs). More particularly, web pages may be processed in a batch process offline. Alternatively, a web page may be processed dynamically in response to a user selection of the web page. An example method of processing a web page to generate a page knowledge graph for the web page will be described in further detail below.

Identification of Query Patterns in Documents

In accordance with various embodiments, pattern matching may be performed to ascertain those query pattern(s) that most closely match text within a given web page. More particularly, the document may be parsed into segments and corresponding entity types may be ascertained. In addition, any browsing context such as the user's current location or user profile data may also be used to generate additional segments (e.g., terms derived from the browsing context), for which corresponding entity types may be identified. In some embodiments, the segmentation and identification of possible corresponding entity types may be accomplished using a technology such as entity SQL or another query language. For example, the text “Gravity Santa Clara AMC showtimes” may be split up into the following segments (showing the token number from, to in parenthesis) along with a (possible) entity type:

Gravity (0)[movie]

Santa (1)

Clara (2)

AMC (3) [theater_name]

showtimes (4)

Santa Clara (1,2) [location]

In other embodiments, a knowledge graph (KG) may be accessed to look up the segments and determine a list of possible entity types for each segment. For example, a knowledge base such as Freebase may be accessed to identify possible entity types for each text segment within a web page. In this manner, text within a given web page may be subdivided into segments and possible entity types may be identified for each segment.

Once the text is divided into segments and possible entity types are identified for each, it is possible to determine whether the text matches any of the query patterns in the taxonomy. In this example, the text “Gravity Santa Clara AMC showtimes” may match a query pattern for the InTheaterMovie:Showtimes use case, as we have:

Gravity (0)[movie]

Santa Clara (1,2) [location]

AMC (3) [theater_name]Showtimes

Therefore, upon identifying a query pattern matching the text, a set of one or more use cases associated with the query pattern may be ascertained.

In more complex examples, the KG or query language may return a list of possible entities types for a segment instead of one entity type (due to ambiguity). The matching of a portion of a document to a given query pattern and corresponding set of use cases therefore has some probability associated therewith. Furthermore, where a browsing context is not available or cannot be ascertained, there may be too many matches. For example, [movie] as a pattern might trigger the Showtimes use case, but can also trigger hundreds of other use cases related to movies.

Identification of Use Cases

The use cases that correspond to those matching query pattern(s) may be identified and optionally ranked to ascertain the use case(s) that are most likely to be relevant to the corresponding text. Since the browsing context is generally limited, there may be numerous matching query patterns and therefore the set of use cases may include hundreds of use cases. In such instances, a subset of the set of use cases may be selected to narrow the possible use cases to a smaller list of use case candidates.

In various embodiments, the set of use cases may be narrowed to a smaller list of use cases (e.g., where the set of use cases determined for the text portion is greater than a minimum threshold amount). More particularly, the set of use cases can be ranked and at least one use case in the set of use cases may be selected according to the ranking. For example, the use cases may be ranked based, at least in part, on the overall relative frequency with which documents matching the use cases are accessed. In some implementations, the set of use cases may be ranked using search query logs and/or other information such as that retrieved from external systems such as Wikipedia or Twitter. For example, clicks and page views associated with documents corresponding to the use cases may be ascertained and a learning feedback model can be generated. Using the model, the set of use cases may be ranked. At least one use case may then be selected from the ranked set of use cases for a given text portion of the document.

Generation of Page Knowledge Graph

A page knowledge graph may be generated for a web page to indicate locations of objects such as entity types, query patterns, use cases and/or solutions to use cases within the web page. In accordance with various embodiments, the page knowledge graph may indicate each (query pattern, use case) pair within the web page and a corresponding location (e.g., region) of the web page in which the (query pattern, use case) is identified. Through performing such mapping for a given web page, the (query pattern, use case) pairs may be associated with specific locations (e.g., regions) within the web page. Solutions to the use cases may be extracted and stored during the mapping process or, alternatively, may be extracted dynamically after the web page has been retrieved for presentation to a user, as will be described in further detail below.

Each URL may potentially be mapped to a large set of query patterns, and each of these patterns may be mapped to a set of use cases. It is therefore possible to compute (e.g., offline) a set of (query, use case) pairs for which a URL represents a possible candidate to contain the answer. In other words, information contained in a given URL can satisfy possibly many (query, use case) pairs. For example, consider a document that lists the production costs of 1,000 popular movies from the past few years. The information contained in that document could therefore solve the “ProductionCost” use case for 1000 movie entities represented in queries.

Extraction of Solutions to Use Cases

While it is possible to extract the information that would be pertinent to each (query, use case) pair (e.g., to ascertain the production costs of 1,000 movies) and store this information, it may be desirable to extract the information that is pertinent to only the (query pattern, use case) pair(s) for a current web page or particular region of the web page.

For example, suppose a document u₁ contains three information items (e.g., facts): use case u1 (ProductionCost), AB, and C. As a result, for this document, there are two possible (query, use case) pairs (Q_{A}, Production Cost) and (Q_{C}, ProductionCost). Thus, a mapping may be generated offline and maintained between the document u1 and these two (query, use case) pairs. At a later time, the information items A and C may be extracted from the document u₁ to solve one or both of these (query, use case) pairs, as is appropriate to the (query, use case) pairs that are pertinent to a given query. In other words, the information may be extracted at a later time (e.g., when a user interacts with that region of the web page). Alternatively, the information may be extracted for all (query, use case) pairs for retrieval at a later time, as described below.

Since the extraction process can be resource intensive, information for (query pattern, use case) pairs may be extracted from documents and possibly further processed in batch process offline and stored for subsequent retrieval at the time of processing a search query. In other words, an offline process may perform an extraction process on a plurality of documents, where text snippets are extracted from a particular document for all corresponding (query pattern, use case) pairs. Each text snippet (or summary generated from multiple text snippets) may be stored in association with the corresponding document and pertinent (query pattern, use case) pair(s). Accordingly, a potential solution for a particular use case may be stored for subsequent retrieval.

Given a use case, a specific query pattern, and a document that possibly contains the answer to the (query, use case) pair, information such as text snippets may be extracted from the document (or retrieved, if previously stored). The use case may include metadata that can be used to perform the extraction task. More particularly, the keywords that are searched for in the document may include segments or terms from the corresponding query pattern. For example, if a query pattern includes a context term of “showtimes,” then this term can be useful as a keyword when analyzing the document.

In addition, in some embodiments, the document or region thereof may be searched for occurrences of terms pertaining to a current browsing context. The browsing context may include information associated with the user such as information from the user's profile. In addition, the browsing context may include information such as a location of a device via which the user is browsing. A number of information extraction algorithms may be applied to extract information from documents for a given (use case, query pattern) pair.

Various existing platforms and tools may be leveraged to assist with the extraction process. For example, the Content Analysis Platform (CAP) may perform pre-processing tasks such as Hyper Text Markup Language (HTML) parsing, tokenization, and language detection, along with further tasks such as detection of entities, classifying pages into categories etc.

In accordance with various embodiments, each URL and corresponding (use case, query pattern) pair may be mapped to a set of text snippets in a data structure, as well as a location or region within the web page to which the (use case, query pattern) pair pertains.

Aggregation and Processing of Snippets

The text snippets may be further aggregated and processed for use in identifying targeted content. For a particular (query pattern, use case) pair, as multiple documents are analyzed to extract text snippets, it is likely that the extraction process will result in redundant information, as well as complementary information that becomes useful when combined.

In one embodiment, each snippet may be collected. A content hash may be created for each snippet to avoid adding identical snippets to the collection. Furthermore, a similarity measurement may be applied between two snippets (e.g., using a standard information retrieval methodology of Term Frequency-Inverse Document Frequency (TFIDF) and cosine similarity). If two snippets are determined to be very similar given the similarity measurement, then one of the two snippets may be discarded.

At least a subset of the text snippets can be further processed to extract semantic structured and/or unstructured data. The extracted data can be used as an input to a knowledge base or a search index. In some embodiments, the data may be used in conjunction with advertising systems to identify an advertisement that is suitable for the particular context.

As described herein, a page knowledge graph may be used to efficiently retrieve contextual information for specific region(s) of a web page as the user interacts with the web page. More particularly, upon detecting user interaction with a particular region of the web page, it is possible to perform a look up in the page knowledge graph for the particular region of the web page to ascertain contextual information for that region. The contextual information may identify or include one or more entities, which may include, for example, query pattern(s), use case(s), and/or solutions to use cases. In accordance with various embodiments, the contextual information ascertained from the page knowledge graph may be provided to a content server for identification of suitable content. In some embodiments, the contextual information may be used to extract or look up further information that may be provided to the content server for identification of suitable content. For example, a lookup may be performed for a pertinent (use case, query pattern) pair to identify the text snippets representing a solution to the use case. Alternatively, pattern matching may be performed to extract text snippets representing the solution to the use case from the web page. The text snippets may be further provided to a content server for use in selecting suitable content for presentation to a user interacting with that region of the web page.

Network

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Content Distribution Network

A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Peer-to-Peer Network

A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

Wireless Network

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Internet Protocol

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

Network Architecture

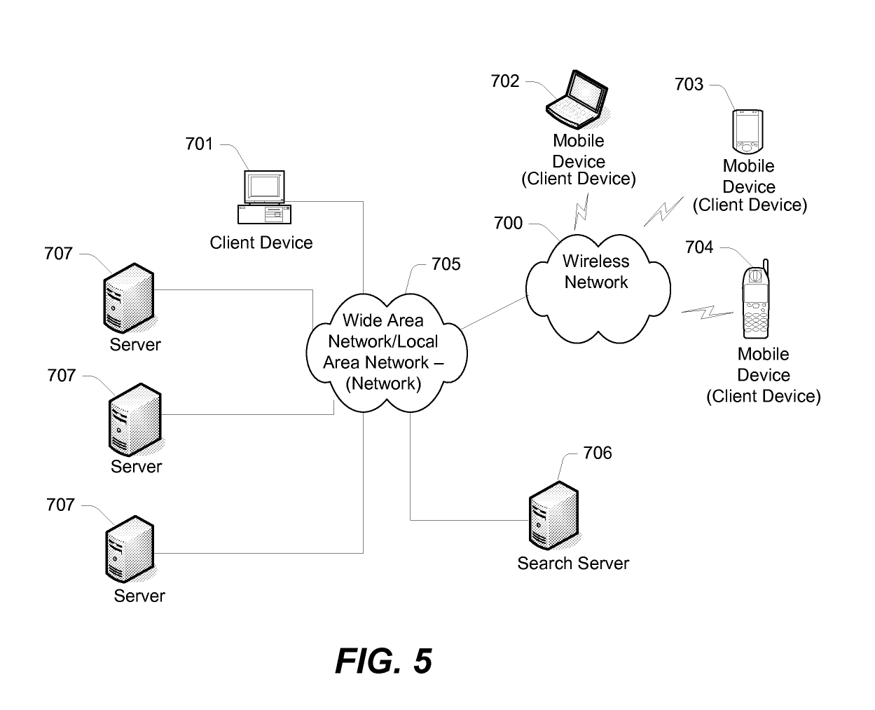

The disclosed embodiments may be implemented in any of a wide variety of computing contexts. FIG. 5 is a schematic diagram illustrating an example embodiment of a network. Other embodiments that may vary, for example, in terms of arrangement or in terms of type of components, are also intended to be included within claimed subject matter. Implementations are contemplated in which users interact with a diverse network environment. As shown, FIG. 5, for example, includes a variety of networks, such as a LAN/WAN 705 and wireless network 700, a variety of devices, such as client devices 701-704, and a variety of servers such as content server(s) 707 and search server 706. The servers may also include an ad server (not shown). As shown in this example, the client devices 701-704 may include one or more mobile devices 702, 703, 704. Client device(s) 701-704 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

The disclosed embodiments may be implemented in some centralized manner. This is represented in FIG. 5 by server(s) 707, which may correspond to multiple distributed devices and data store(s). The server(s) 707 and/or corresponding data store(s) may store user account data, user information, and/or content.

Server

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Content Server

A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

Client Device

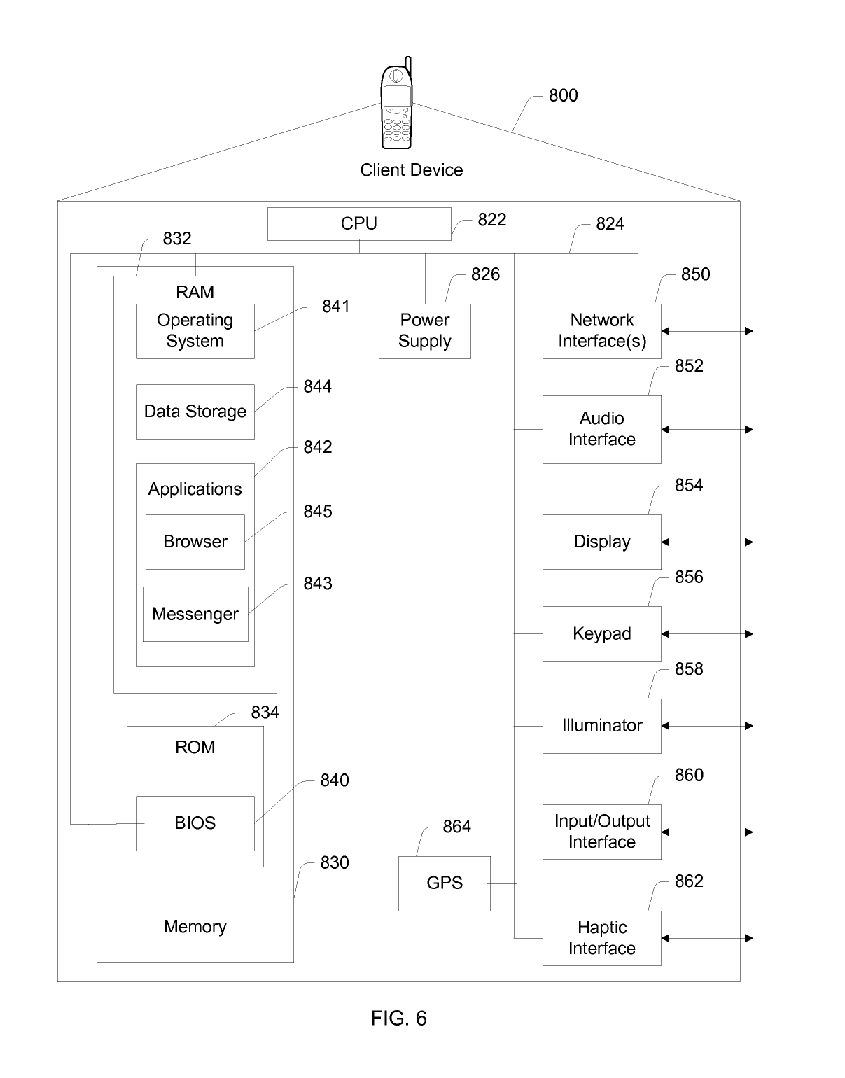

FIG. 6 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. A portable device may also be referred to as a mobile device or handheld device.

As shown in this example, a client device 800 may include one or more central processing units (CPUs) 822, which may be coupled via connection 824 to a power supply 826 and a memory 830. The memory 830 may include random access memory (RAM) 832 and read only memory (ROM) 834. The ROM 834 may include a basic input/output system (BIOS) 840.

The RAM 832 may include an operating system 841. More particularly, a client device may include or may execute a variety of operating systems, including a personal computer operating system, such as a Windows, iOS or Linux, or a mobile operating system, such as iOS, Android, or Windows Mobile, or the like. The client device 800 may also include or may execute a variety of possible applications 842 (shown in RAM 832), such as a client software application such as messenger 843, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 800 may also include or execute an application to communicate content, such as, for example, textual content, multimedia content, or the like, which may be stored in data storage 844. A client device may also include or execute an application such as a browser 845 to perform a variety of possible tasks, such as browsing, searching, playing various forms of content, including locally stored or streamed video, or games (such as fantasy sports leagues).

The client device 800 may send or receive signals via one or more interface(s). As shown in this example, the client device 800 may include one or more network interfaces 850. The client device 800 may include an audio interface 852. In addition, the client device 800 may include a display 854 and an illuminator 858. The client device 800 may further include an Input/Output interface 860, as well as a Haptic Interface 862 supporting tactile feedback technology.

The client device 800 may vary in terms of capabilities or features. Claimed subject matter is intended to cover a wide range of potential variations. For example, a cell phone may include a keypad such 856 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 864 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

In some embodiments, an identity of the user (e.g., owner) of the client device may be statically configured. Thus, the device may be keyed to an owner or multiple owners. In other embodiments, the device may automatically determine the identity of the user of the device. For instance, a user of the device may be identified by deoxyribonucleic acid (DNA), retina scan, and/or finger print.

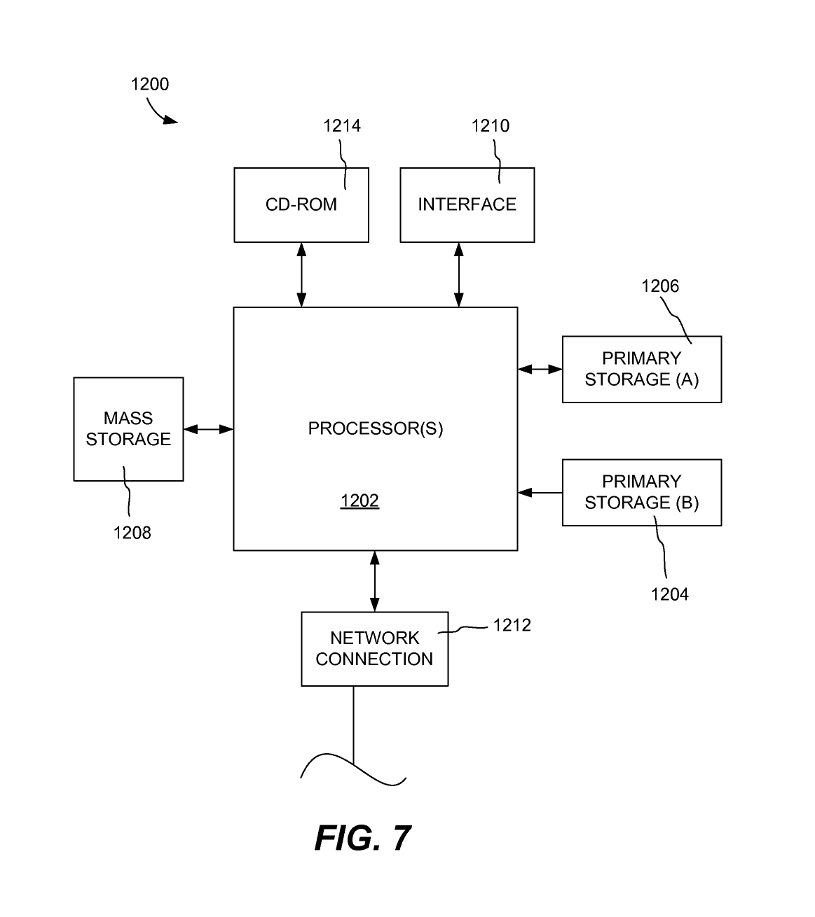

FIG. 7 illustrates a typical computer system that, when appropriately configured or designed, can serve as a system via which various embodiments may be implemented. The computer system 1200 includes any number of CPUs 1202 that are coupled to storage devices including primary storage 1206 (typically a RAM), primary storage 1204 (typically a ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as optical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which various embodiments are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques may be implemented in any suitable combination of software and/or hardware system, such as a web-based server or desktop computer system. Moreover, a system implementing various embodiments may be a portable device, such as a laptop or cell phone. An apparatus and/or web browser may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
obtaining location information indicating a region of a web page with which a user is interacting, the region being one of a plurality of regions of the web page;
ascertaining contextual information pertaining to the region of the web page with which the user is interacting;
obtaining content based, at least in part, upon the contextual information pertaining to the region of the web page with which the user is interacting; and
providing the content for presentation to the user.

2. The method as recited in claim 1, further comprising:
obtaining page information associated with the web page, wherein the page information identifies or indicates locations of a plurality of objects within the web page;
wherein the contextual information is ascertained based, at least in part, upon the page information.

3. The method as recited in claim 2, wherein the page information further indicates relationships between at least a portion of the plurality of objects.

4. The method as recited in claim 1, wherein the contextual information pertaining to the region of the web page with which the user is interacting identifies or indicates locations of one or more objects within the region of the web page.

5. The method as recited in claim 4, wherein the objects comprise at least one of entities, concepts, or categories.

6. The method as recited in claim 1, wherein the content comprises an advertisement.

7. The method as recited in claim 1, wherein providing the content is performed without reloading the web page.

8. The method as recited in claim 1, wherein obtaining location information, ascertaining contextual information, obtaining content, and providing the content are performed by at least one of a server or a browser of a device.

9. An apparatus, comprising:
a processor; and
a memory, at least one of the processor or the memory being configured for:
obtaining location information indicating a region of a web page with which a user is interacting, the region being one of a plurality of regions of the web page;
ascertaining contextual information pertaining to the region of the web page with which the user is interacting;
obtaining content based, at least in part, upon the contextual information pertaining to the region of the web page with which the user is interacting; and
providing the content for presentation to the user.

10. The apparatus as recited in claim 9, at least one of the processor or the memory being configured for performing operations, further comprising:
obtaining page information associated with the web page, wherein the page information identifies or indicates locations of a plurality of objects within the web page;
wherein the contextual information is ascertained based, at least in part, upon the page information.

11. The apparatus as recited in claim 10, wherein the page information further indicates relationships between at least a portion of the plurality of objects.

12. The apparatus as recited in claim 9, wherein the contextual information pertaining to the region of the web page with which the user is interacting identifies or indicates locations of one or more objects within the region of the web page.

13. The apparatus as recited in claim 12, wherein the objects comprise at least one of entities, concepts, or categories.

14. The apparatus as recited in claim 9, wherein the content comprises an advertisement.

15. The apparatus as recited in claim 9, wherein providing the content is performed without reloading the web page.

16. A system, comprising:
means for obtaining location information indicating a region of a web page with which a user is interacting, the region being one of a plurality of regions of the web page;
means for ascertaining contextual information pertaining to the region of the web page with which the user is interacting;
means for obtaining content based, at least in part, upon the contextual information pertaining to the region of the web page with which the user is interacting; and
means for providing the content for presentation to the user.

17. The system as recited in claim 16, further comprising:
means for obtaining page information associated with the web page, wherein the page information identifies or indicates locations of a plurality of objects within the web page;
wherein the contextual information is ascertained based, at least in part, upon the page information.

18. The system as recited in claim 16, wherein the contextual information pertaining to the region of the web page with which the user is interacting identifies or indicates locations of one or more objects within the region of the web page.

19. The system as recited in claim 16, wherein the content comprises an advertisement.

20. The system as recited in claim 16, wherein providing the content is performed without reloading the web page.
